(19) United States
(12) Patent Application Publication
(10) Pub. No.: US 2026/0002374 A1
(43) Pub. Date: Jan. 1, 2026

(54) HAND-HELD SWIMMING POOL CLEANING APPARATUS AND CONTROL METHOD THEREOF

(71) Applicant: Aiper Global Pte. Ltd., Singapore (SG)

(72) Inventors: Fengli ZHAO, Suzhou (CN); Yong LI, Suzhou (CN); Fengfeng LU, Suzhou (CN)

(73) Assignee: Aiper Global Pte. Ltd., Singapore (SG)

(21) Appl. No.: 19/319,563

(22) Filed: Sep. 4, 2025

(30) Foreign Application Priority Data
Sep. 5, 2024 (CN) 202411242122.1

(51) Int. Cl. E04H 4/16; B01D 29/11; B01D 29/60; B01D 29/66; B01D 35/26; B01D 37/04; C02F 1/00; C02F 103/42; F04D 15/00; F04D 29/70

(52) U.S. Cl. CPC E04H 4/1636; B01D 29/117; B01D 29/60; B01D 29/66; B01D 35/26; B01D 37/04; C02F 1/001; C02F 1/008; F04D 15/0027; F04D 29/708; B01D 2201/167; C02F 2103/42; C02F 2201/005; C02F 2303/16

(57) ABSTRACT

The present disclosure provides a hand-held swimming pool cleaning apparatus and a corresponding control method. The apparatus includes a housing having at least one water suction inlet and at least one water discharge outlet, a water pump, and a detachable filtering device. The water pump operates in two selectable modes: a filtering mode and a backwashing mode. In the filtering mode, the pump directs water flow through the suction inlet, across the filtering device, and out through the discharge outlet to collect debris. In the backwashing mode, the pump reverses the flow direction, flushing water through the filtering device opposite to the filtering flow, thereby washing and unclogging the filter. This self-cleaning capability eliminates the need for manual filter washing, extends the effective service life of the filtering device, delays clogging, increases the debris collection box capacity, and prolongs continuous operation. Overall, the apparatus improves cleaning efficiency and enhances user convenience.

### FIELD

The present application relates to the technical field of swimming pool cleaning, and in particular, to a hand-held swimming pool cleaning apparatus and a control method thereof.

### BACKGROUND

At present, a water pump and a filter mesh are generally disposed in a swimming pool cleaning apparatus having a water-filtering function. When the water pump operates, water flow and impurities are sucked from the bottom of the apparatus and flow through the filter mesh, the impurities are filtered by filter mesh so that the impurities and wastes stay in a debris collection box, whereas clean water flow through the filter mesh and is discharged from a water outlet. However, during the filtration, the filter mesh is apt to be clogged by the impurities, the clogged filter mesh will affect the channel of the water flow so that the apparatus cannot complete the debris colleting and cleaning work. A user needs to clean the filter mesh frequently, which affects the efficiency of the cleaning work as well as the user experience.

### SUMMARY

To address at least one technical problem mentioned above, the present disclosure provides a hand-held swimming pool cleaning apparatus and a control method thereof.

In some embodiments of the present disclosure, there is provided a hand-held swimming pool cleaning apparatus, including: a housing including at least one water suction inlet and at least one water discharge outlet; a water pump and a filtering device, where an operating mode of the water pump includes a filtering mode and a backwashing mode, in the filtering mode, the water pump enables water flow to flow in through the water suction inlet, pass through the filtering device and flow towards and out of the water discharge outlet; the filtering device is detachably connected to the housing; the water pump is switchable from the filtering mode to the backwashing mode; in the backwashing mode, the water pump enables the water flow to pass through the filtering device in a direction opposite to a water flow direction in the filtering mode, to wash the filtering device.

In some possible implementations, the water pump includes a motor and an impeller, the water pump enters the filtering mode in a case where the motor rotates in a forward direction, and the water pump enters the backwashing mode in a case where the motor rotates in a reverse direction.

In some possible implementations, the filtering device further includes an outer cover and a filtering member, the outer cover is detachably connected to the housing, and at least a part of the filtering member is placed within the outer cover.

In some possible implementations, the outer cover includes a handle.

In some possible implementations, the filtering member includes a water flow inlet, and a one-way valve is disposed at the water flow inlet.

In some possible implementations, the housing is provided with an opening, the opening is communicated with the water suction inlet.

In some other embodiments of the present disclosure, there is provided a method of controlling a hand-held swimming pool cleaning apparatus, an operating mode of the hand-held swimming pool cleaning apparatus includes a filtering mode and a backwashing mode, the method includes: in a case where the hand-held swimming pool cleaning apparatus is in the filtering mode, controlling, by a water pump, water flow to flow in through a water suction inlet, pass through a filtering device, and flow towards and out of a water discharge outlet; until the hand-held swimming pool cleaning apparatus is switched to the backwashing mode, controlling, by the water pump, the water flow to pass through the filtering device along a direction opposite to a water flow direction in the filtering mode to wash the filtering device; the backwashing mode is switched based on one of following conditions: duration in which the hand-held swimming pool cleaning apparatus is in the filtering mode having reached a preset duration condition, or clogging of the filtering device having been detected, or a backwash control button on the hand-held swimming pool cleaning apparatus having been triggered.

In some possible implementations, the backwashing mode further comprises: after the controlling, by the water pump, the water flow to flow through the filtering device in a reverse direction, controlling, by the water pump, the water flow to flow through the filtering device in a forward direction.

In some possible implementations, the backwashing mode further comprises: controlling the water pump to stop operating in an interval between generating forward water flow and generating reverse water flow.

In some possible implementations, duration of controlling the water flow to flow through the filtering device in the reverse direction is in a range of 2 s-15 s.

The following advantageous effects are achieved by implementing the embodiments of the present disclosure.

The hand-held swimming pool cleaning apparatus of the present disclosure has two modes, namely, the filtering mode and the backwashing mode. In the filtering mode, the water pump enables the water flow to flow from the water suction inlet to the water discharge outlet, and the filtering device can filter impurities in the water flow. In the backwashing mode, the water pump enables the water flow to pass through the filtering device in a direction opposite to the water flow direction in the filtering mode to wash the filtering device, to prevent the impurities and wastes from clogging the filtering device. The hand-held swimming pool cleaning apparatus of the present disclosure has a self-cleaning function without requiring a user to manually wash, and the filtering device can be cleaned conveniently, which helps to improve the user experience. Furthermore, the self-cleaning function can extend the time of clogging the filtering device, improve the filling rate of a debris collection box, and thus extend the constant use period of the apparatus and improve the working efficiency.

It should be understood that the above general description and detailed description hereunder are only exemplary and illustrative and not intended to limit the present disclosure.

Other features and aspects of the present disclosure will become apparent from the following detailed description of exemplary embodiments with reference to the accompanying drawings.

### BRIEF DESCRIPTION OF THE DRAWINGS

In order to more clearly illustrate the technical solutions and advantages in the embodiments of the present specification or in the prior art, a brief introduction will be made below to accompanying drawings required for the description of embodiments or prior art. Obviously, the accompanying drawings in the description below are only some embodiments of the present specification. For persons of ordinary skill in the art, other accompanying drawings can also be obtained from these accompanying drawings without creative labor.

FIG. 1 is a first structural schematic drawing of a hand-held swimming pool cleaning apparatus according to an embodiment of the present disclosure;

FIG. 2 is a second structural schematic drawing of a hand-held swimming pool cleaning apparatus according to an embodiment of the present disclosure;

FIG. 3 is a third structural schematic drawing of a hand-held swimming pool cleaning apparatus according to an embodiment of the present disclosure;

FIG. 4 is a first structural schematic drawing of a water pump according to an embodiment of the present disclosure;

FIG. 5 is a second structural schematic drawing of a water pump according to an embodiment of the present disclosure;

FIG. 6 is a structural schematic drawing of a filtering device according to an embodiment of the present disclosure;

FIG. 7 is a structural schematic drawing of a filtering member according to an embodiment of the present disclosure;

FIG. 8 is a sectional view of a filtering device according to an embodiment of the present disclosure;

FIG. 9 illustrates operating principles of a hand-held swimming pool cleaning apparatus according to an embodiment of the present disclosure;

FIG. 10 is a flowchart showing steps of a control method according to an embodiment of the present disclosure; and

FIG. 11 is a system block diagram of an electronic device according to an embodiment of the present disclosure.

In the accompanying drawings, reference numbers are listed as follows:
1, Housing; 11, Water suction inlet; 12, Water discharge outlet; 2, Water pump; 21, Motor; 22, Impeller; 3, Filtering device; 31, Outer cover; 311, Handle; 32, Filtering member; 321, One-way valve; 4, Backwash control button.

### DETAILED DESCRIPTION OF EMBODIMENTS

The technical solutions in embodiments of the present specification will be described clearly and completely below with reference to the accompanying drawings in embodiments of the present specification. Obviously, the described embodiments are only partial embodiments of the present specification and not all embodiments. Based on embodiments in the present specification, all other embodiments obtained by persons of ordinary skill in the art without creative labor all fall within the protection scope of the present disclosure.

It should be illustrated that terms such as “first” and “second” in the specification, claims and accompanying drawings of the present disclosure are used to distinguish similar objects, and not necessarily to describe a specific order or sequential order. It should be understood that data used in this way are interchangeable where appropriate, so that the embodiments of the present disclosure described herein can be implemented in an order other than those orders shown or described herein. In addition, terms such as “include/comprise” and “have” and any variants thereof are intended to cover non-exclusive inclusion, for example, processes, methods, systems, products or servers comprising a series of steps or units are not necessarily limited to those steps or units clearly listed, and instead may include other steps or units which are not clearly listed or are intrinsic for these processes, methods, systems, products or servers.

Various exemplary embodiments, features and aspects of the present disclosure will be described in detail below with reference to the accompanying drawings. The same reference numbers in the accompanying drawings represent elements with the same or similar functions. While various aspects of the embodiments are illustrated in the accompanying drawings, the accompanying drawings are not necessarily drawn to scale unless specifically indicated.

The word “exemplary” used exclusively herein means “serve as an example, embodiment, or illustration”. Any embodiment described herein as “exemplary” is not necessarily to be construed as preferred or advantageous over other embodiments.

The term “and/or” used in the text only depicts an association relationship between associated objects and represents that three relationships might exist, for example, “A and/or B” may represent three cases, namely, A exists individually, both A and B coexist, and B exists individually. In addition, the term “at least one” used herein represents any one of multiple elements or any combination of at least two of the multiple elements, for example, at least one of A, B and C may represent at least one or more elements selected from a set constituted by A, B and C.

In addition, a lot of specific details are given in the following specific implementations to better illustrate the present disclosure. Persons of ordinary skill in the art should understand that the present disclosure can also be implemented without some specific details. In some examples, methods, means, elements and circuits well known to persons of ordinary skill in the art are not described in detail to highlight the essence of the present disclosure.

It can be noted that directional terms used in embodiments of the present disclosure should refer to a posture of the hand-held swimming pool cleaning apparatus in an operated state, and the apparatus is placed horizontally to better display the details in the accompanying drawings of the specification.

To address the problem of frequent clogging of the filter mesh of the swimming pool cleaning apparatuses in the related art, embodiments of the present disclosure provide a hand-held swimming pool cleaning apparatus having a self-cleaning function which is implemented in a backwash manner. The hand-held swimming pool cleaning apparatus can change the flow direction of water flow therein based on a change of the operating mode, so that water flow backwashing the filter mesh is formed upon activation of the self-cleaning function of the hand-held swimming pool cleaning apparatus such that impurities on the filter mesh fall into a debris collection box, thereby solving the problem of the reduction of the cleaning efficiency caused by the clogging of the filter mesh.

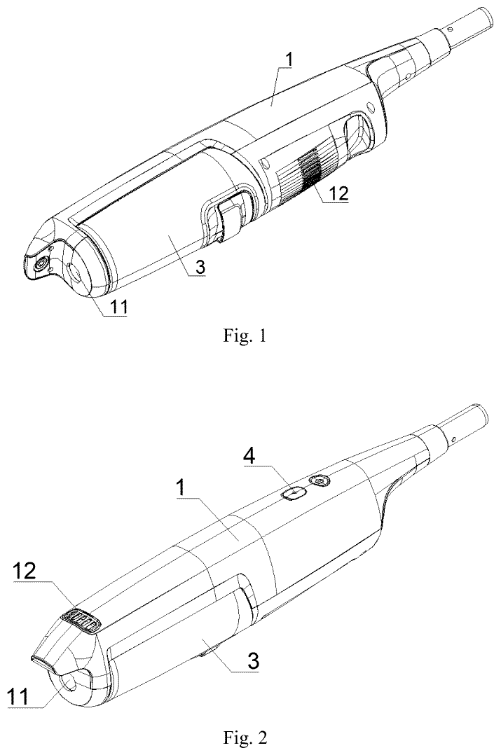

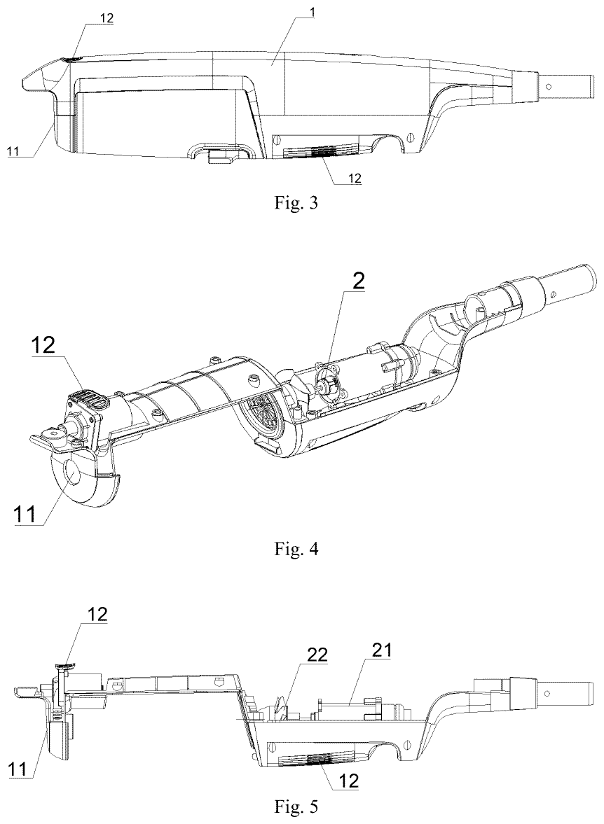

Referring to FIG. 1 to FIG. 9, a hand-held swimming pool cleaning apparatus according to an embodiment of the present disclosure includes: a housing 1 including at least one water suction inlet 11 and at least one water discharge outlet 12; a water pump 2 and a filtering device 3, wherein an operating mode of the water pump 2 includes a filtering mode and a backwashing mode, and in the filtering mode, the water pump 2 enables water flow to flow in through the water suction inlet 11, pass through the filtering device 3 and flow towards and out of the water discharge outlet 12; the filtering device is detachably connected to the housing 1; wherein the water pump 2 is switchable from the filtering mode to the backwashing mode, and in the backwashing mode, the water pump 2 enables the water flow to pass through the filtering device 3 in a direction opposite to a water flow direction in the filtering mode, to wash the filtering device 3.

In the embodiments of the present disclosure, the housing 1 of the hand-held swimming pool cleaning apparatus may be provided with at least one water suction inlet 11 and at least one water discharge outlet 12. The number of the water suction inlet 11 and water discharge outlet 12 is not limited. Specifically, the number of the water suction inlet 11 may be the same as or different from the number of the water discharge outlet 12. For example, both the number of the water suction inlet 11 and the number of the water discharge outlet 12 are one. Alternatively, the number of the water suction inlet 11 is one, and the number of the water discharge outlets 12 is two. Alternatively, the number of the water suction inlets 11 is two, and the number of the water discharge outlets 12 is three.

In the embodiments of the present disclosure, positions of the water suction inlet 11 and the water discharge outlet 12 are not limited. That is to say, the water suction inlet 11 and the water discharge outlet 12 may be arranged in a vertical direction, or may be arranged in a horizontal direction, or may be arranged in other angular directions. In an exemplary embodiment, one water suction inlet 11 may be disposed at the bottom of the housing 1, one water discharge outlet 12 may be disposed at the top of the housing 1, and the water pump 2 and the filtering device 3 may be disposed between the water suction inlet 11 and the water discharge outlet 12.

Furthermore, on the basis of the above exemplary embodiment, the bottom of the housing 1 is provided with another water discharge outlet 12 which is opened or closed in response to the mode switching of the water pump 2. Specifically, in a case where the water pump 2 is in the filtering mode, the water discharge outlet 12 at the bottom of the housing 1 is closed, and water flows in through the water suction inlet 11, passes through the filtering device 3, and then flows out of the water discharge outlet 12 at the top of the housing 1. In a case where the water pump 2 is in the backwashing mode, the water discharge outlet 12 at the bottom of the housing 1 is opened. In the backwashing mode, the water pump 2 enables the water flow to pass through the filtering device 3 in a direction opposite to the water flow direction in the filtering mode so that the filtering device 3 is washed, and the washing water flow finally flows out from the water discharge outlet 12 at the bottom of the housing 1.

It should be noted that the water suction inlet 11 in the embodiments of the present disclosure should be understood as a water flow suction inlet in a case where the hand-held swimming pool cleaning apparatus is in a normal operating mode. Correspondingly, the water discharge outlet 12 is a water flow discharge outlet in the normal operating mode. That is to say, the present disclosure does not limit that the water flow may only flow in through the water suction inlet 11 or may only flow out through the water discharge outlet 12. In a case where the hand-held swimming pool cleaning apparatus is in another operating mode, the water flow may flow in through the water discharge outlet 12 and then flow out through the water suction inlet 11; alternatively, the water flow may flow in through one water discharge outlet 12 and then flow out through another water discharge outlet 12. In some possible embodiments, the normal operating mode of the hand-held swimming pool cleaning apparatus corresponds to the filtering mode of the water pump 12, and the another operating mode of the hand-held swimming pool cleaning apparatus corresponds to the backwashing mode of the water pump 12.

In the embodiments of the present disclosure, the water pump 2 has at least two different operating modes, namely, the above-mentioned filtering mode and backwashing mode, and the water flow directions guided by the water pump 2 in the two modes are opposite. Here, the opposite water flow directions should be understood in a way that the directions in which the water flow flows thorough the filtering device 3 are opposite, and cannot limit that the water inlet and outlet are swapped in the two modes.

For example, in a specific embodiment, referring to FIG. 2 to FIG. 5, one water suction inlet 11 and one water discharge outlet 12 are disclosed below the filtering device 3, and another water discharge outlet 12 is disposed above the filtering device 3. In a case where the water pump is in the filtering mode, the water flow flows through the water suction inlet 11 below the filtering device 3 towards the water discharge outlet 12 above the filtering device 3. In a case where the water pump is in the backwashing mode, the water flow may flow through the water discharge outlet 12 above the filtering device 3 towards the water suction inlet 11 below the filtering device 3, that is to say, the water flow inlet and outlet are swapped in the two modes, and no new water flow inlet and outlet are used after the mode switching. Alternatively, the water flow may flow through the water discharge outlet 12 above the filtering device 3 towards the water discharge outlet 12 below the filtering device 3, i.e., new water flow inlet and outlet are used after the mode switching.

Embodiments of the present disclosure do not limit the specific structure selection of the water pump 2, namely, do not limit principles for the water pump 2 to achieve the above-mentioned two different operating modes. For example, the water pump 2 may be configured to have a plurality of water inlets and/or a plurality of water outlets. The water pump 2 is provided with an adjusting device, and the adjusting device can adjust the water inlets and/or the water outlets so as to change the flow direction of the water flow directed by the water pump 2, so that the water flow directions are opposite in two different operating modes of the water pump 2. Alternatively, the water pump 2 may also be configured as a water pump set formed by two independent water pumps, and the water flow directions directed by the two independent water pumps are opposite to each other, and the water pump set is configured such that only one independent water pump operates at a time, thereby achieving the switching of the above two different operating modes. Alternatively, the water pump 2 may be configured as an impeller pump having a bi-directional flow direction. Upon rotating in a forward direction, the impeller pump can direct the water flow to flow in one direction, and upon rotating in a reverse direction, the impeller pump can direct the water flow to flow in an opposite direction.

In some embodiments, the water pump 2 is configured as an impeller pump. Referring to FIG. 4 and FIG. 5, the water pump 2 includes a motor 21 and an impeller 22, the water discharge outlet 12 at the top of the housing 1 is located above the impeller 22, the filtering device 3 is located below the impeller 22, and the water suction inlet 11 at the bottom of the housing 1 is located below the filtering device 3. In a case where the motor 21 rotates forwardly, the water pump 2 enters the filtering mode, the impeller 22 directs the water flow below the impeller 22 to flow towards above the impeller 22, whereupon the water flow direction is from bottom to top, and the filtering device 3 filters the water that flows from bottom to top. In a case where the motor 21 rotates reversely, the water pump 2 enters the backwashing mode, and the impeller 22 directs the water flow above the impeller 22 to flow towards below the impeller 22, whereupon the water flow direction is from top to bottom, and the water flow flowing from top to bottom washes the filtering device 3, so that impurities clogging the filtering device 3 fall off. In the present embodiment, the shape and structure of the impeller 22 are not limited. The shape and structure of the impeller 22 may be determined according to the shape of the housing 1 and the shape of a flow channel inside the housing 1. For example, the flow channel inside the housing 1 is an axial flow channel, and correspondingly, the impeller 22 should be selected and configured as an axial impeller.

In the embodiments of the present disclosure, the filtering device 3 is detachably connected to the housing 1. In a case where the hand-held swimming pool cleaning apparatus is in the filtering mode, the filtering device 3 filters water flow containing impurities and wastes, and collects and retains the impurities and wastes in the water flow until the impurities accumulated on the filtering device 3 meet a fixed condition, and then the user may remove the filtering device 3 from the housing 1 to dump the impurities and clean the filtering device 3. The present embodiment does not limit the specific structural design of the filtering device 3. As known from the above configuration, the filtering device 3 should be a functional combination including a filter mesh and a debris collecting box, that is to say, the filtering device 3 will filter and collect the impurities and wastes in the water flow until the debris collecting box is full. The design of the detachable connection of the filtering device 3 is conducive to extend the duration of single cleaning operation.

In some embodiments, the filtering device 3 includes an outer cover 31 and a filtering member 32, where the outer cover 31 is detachably connected to the housing 1, and at least a part of the filtering member 32 is placed within the outer cover 31. In the present embodiment, the outer cover 31 forms a hollow cylinder-like structure after being mounted on the housing 1, the hollow portion of the cylinder-like structure serves as a flow channel of the water flow under the filtering mode, and the filtering member 32 is disposed in the flow channel of the water flow under the filtering mode.

In some embodiments, the outer cover 31 is provided with an opening that is communicated with the water suction inlet 11. Specifically, the bottom of the housing 1 is provided with a water suction port 11, and the bottom of the outer cover 31 is provided with an opening, and the opening is matched with the water suction inlet 11. In a case where the outer cover 31 is mounted on the housing 1, the opening communicates with the water suction inlet 11.

In some embodiments, referring to FIG. 4 to FIG. 6, the outer cover 31 has a separate-channel design. Based on the structure, the internal water flow channel of the hand-held swimming pool cleaning apparatus is formed by splicing two channels, i.e., a water flow channel in the outer cover 31 and a water flow channel in the housing 1 respectively. The water flow channel in the housing 1 acts as an active channel within which the water pump 2 is disposed to direct the water flow to flow, and the water flow channel in the outer cover 31 acts as a passive channel.

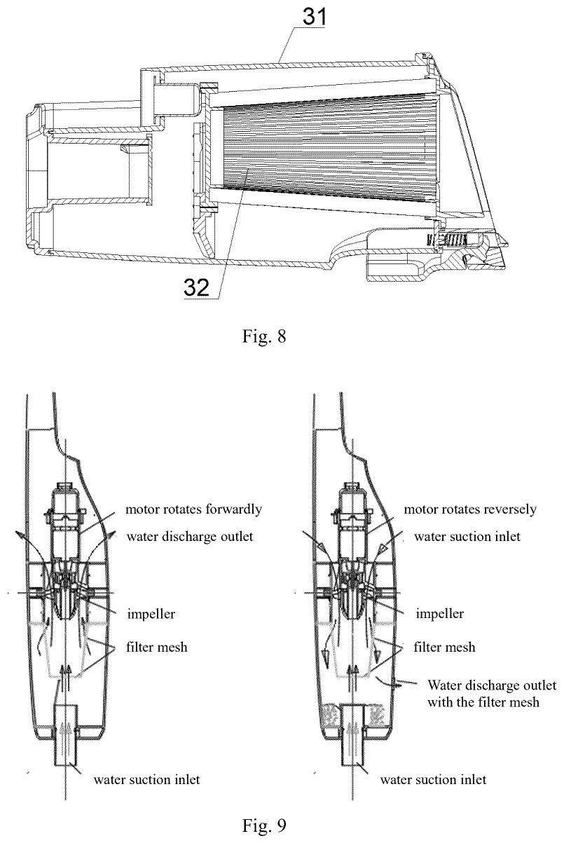

Based on the outer cover 31 with the separate-channel design, in a further embodiment, the filtering member 32 may be completely disposed inside the outer cover 31. In order to increase the contact area between the filtering member 32 and the water flow to enhance the filtering effect, referring to FIG. 7 to FIG. 8, the filtering member 32 may include a filter mesh with a cage structure. Specifically, a skeleton of the cage structure is formed by assembling a plurality of ribs, and the filter mesh is mounted on the outer side of the skeleton. In a case where the water flow flows from bottom to top, the water flow sufficiently contacts the filter mesh, and impurities in the water flow are intercepted by the filter mesh and remain on the outer side of the cage structure, and clean water flow flows into the inner side of the cage structure and then flows towards the water discharge outlet 12 at the top of the housing 1.

In some embodiments, referring to FIG. 7 to FIG. 9, the filtering member includes a water flow inlet provided with a one-way valve 321, and the one-way valve 321 is configured to open in a case where the water pump 2 is in the filtering mode and is configured to be closed in a case where the water pump 2 is in the backwashing mode. Based on the above configuration, in a case where the water pump 2 is in the filtering mode, the one-way valve 321 is opened, the water flow flows in through the water suction inlet 11 at the bottom of the housing 1 and flows out through the water discharge outlet 12 at the top of the housing 1 after being filtered by the filter mesh. In a case where the water pump 2 is in the backwashing mode, the one-way valve 321 is closed, the water flow flows in through the water discharge outlet 12 at the top of the housing 1 and washes the filter mesh so that the impurities and wastes on the filter mesh fall off from the filter mesh. Since the one-way valve 321 is already closed, the fallen impurities and wastes can no longer flow out through the water suction inlet 11 at the bottom of the housing 1, thereby avoiding the contamination caused by the backwashing process to the water suction inlet 11. In the present embodiment, the specific structure selection of the one-way valve 321 is not limited. Since the function of the one-way valve 321 is to avoid the outflow of the impurities and wastes in the filtering device 3 in the backwashing mode, the one-way valve 321 may also be replaced with other members having the above-mentioned function and effect.

In a possible embodiment, the one-way valve 321 may be replaced with a rotary member comprising a filter mesh. In a case where the water pump 2 is in the filtering mode, the rotary member rotates such that the filter mesh is away from the water flow inlet of the filtering member. In a case where the water pump 2 is switched to the backwashing mode, the rotary member rotates such that the filter mesh clogs the water flow inlet of the filtering member, thereby preventing the impurities and wastes from flowing out of the water flow inlet of the filtering member in the backwashing mode.

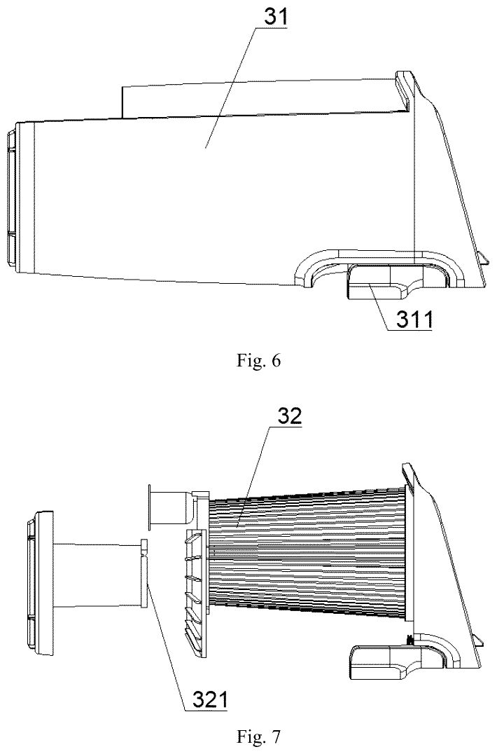

In some embodiments, referring to FIG. 6 to FIG. 8, the outer cover 31 further includes a handle 311. Furthermore, the housing 1 is provided with a locking member, the handle 311 is a movable member, and the locking member cooperates with the handle 311. In a case where the outer cover 31 is mounted on the housing 1, the handle 311 is locked on the locking member. In a process of detaching the filtering device 3 by the user, the handle 311 may be unlocked from the locking member by pulling the handle 311, and then the outer cover 31 as a whole may be removed from the housing 1. The specific configurations of the handle 311 and the locking member are not limited in the present embodiment. The handle 311 and the locking member may achieve the locking based on a mechanical structure, or based on an electrically-driven member, a magnetically-driven member, or in other forms.

In some embodiments, referring to FIG. 2, the hand-held swimming pool cleaning apparatus is further provided with a backwash control button 4. After the backwash control button 4 is triggered, the water pump 2 enters the backwashing mode. Based on the backwash control button 4, the user may manually control the hand-held swimming pool cleaning apparatus to backwash, thereby being conducive to extend the duration of a single continuous use of the hand-held swimming pool cleaning apparatus.

The above multiple embodiments have described in detail the structures and the principles of the self-cleaning function of the hand-held swimming pool cleaning apparatus. It should be understood that features in different embodiments may be combined with one another to form new solutions without conflicts, which will not be additionally described in the present disclosure.

Embodiments of the present disclosure also provide a method for controlling a hand-held swimming pool cleaning apparatus. The method can further extend the time of clogging the filter mesh, improve the filling rate of the debris collection box, and thus improve the working efficiency of the hand-held swimming pool cleaning apparatus.

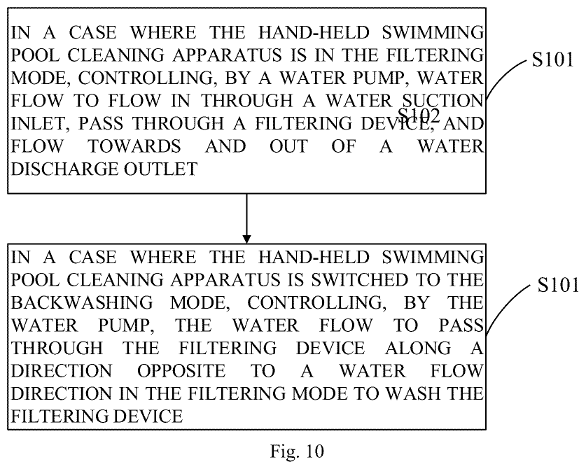

FIG. 10 is a flowchart showing steps of a control method according to an embodiment of the present disclosure. The operating mode of the hand-held swimming pool cleaning apparatus includes a filtering mode and a backwashing mode. As shown in FIG. 10, the method includes following steps.

In step S101, in a case where the hand-held swimming pool cleaning apparatus is in the filtering mode, water flow is controlled by the water pump 2 to flow in through the water suction inlet 11, pass through the filtering device 3, and flow towards and out of the water discharge outlet 12.

In step S102, until the hand-held swimming pool cleaning apparatus is switched to the backwashing mode, the water flow is controlled by the water pump 2 to pass through the filtering device 3 in a direction opposite to a water flow direction in the filtering mode to wash the filtering device 3.

In the embodiments of the present disclosure, the mode-switching manner of the hand-held swimming pool cleaning apparatus is not limited. That is to say, the hand-held swimming pool cleaning apparatus may automatically switch mode, that is, an auto-run switching program is set in the apparatus. After the user activates the apparatus, the apparatus enters the filtering mode, and automatically switches to the backwashing mode in a case where a preset condition is met, and enters the filtering mode again after completing self-cleaning. Alternatively, the hand-held swimming pool cleaning apparatus may employ a manual switching mode, that is, the user may switch the apparatus from other modes directly to the backwashing mode by issuing a switch instruction to the apparatus. It should be understood that the preset condition of the automatic switching scheme is not limited in the above configuration, that is, the preset condition may be one or more of a time condition, a temperature condition, and other feedback signal conditions. In addition, the manner of issuing the switch instruction in the above manual switching scheme is not limited. The user may issue an instruction based on a physical function button on the hand-held swimming pool cleaning apparatus, or may issue an instruction remotely based on an electronic terminal (a mobile phone, a tablet computer, or the like).

In some embodiments, the backwashing mode is switched based on one of the following conditions: duration in which the hand-held swimming pool cleaning apparatus is in the filtering mode having reached a preset duration condition, or clogging of the filtering device 3 having been detected, or a backwash control button 4 on the hand-held swimming pool cleaning apparatus having been triggered.

In the above embodiments, the backwashing mode includes three switching conditions, wherein the first condition is an operation duration condition. The reason for setting the operation duration condition is that, as the hand-held swimming pool cleaning apparatus operating in the filtering mode for a long time, the filter mesh in the filtering device 3 will be gradually clogged. With the operation duration condition being set, the apparatus may automatically enter the backwashing mode to wash the filter mesh at intervals, thereby extending the duration of a single continuous use.

The second condition is an automatic detecting condition. The reason for setting the automatic detecting condition is as follows: the content of impurities in the swimming pool water in which the hand-held swimming pool cleaning apparatus is located varies; if there are more impurities in the water flow, the filter mesh is already seriously clogged whilst the hand-held swimming pool cleaning apparatus does not reach the operation duration condition. Therefore, it is necessary to detect the clogging degree of the filter mesh in real time, to prevent the apparatus from operating in the filter mesh-clogged state in a long period of time, thereby protecting the hand-held swimming pool cleaning apparatus. The present embodiment does not limit the manner of detecting the clogging degree of the filter mesh. For example, the clogging degree of the filter mesh may be fed back by detecting the water flow resistance via a pressure sensor, or the clogging degree of the filter mesh may also be determined by detecting an electrical current value of the motor 21 in the water pump 2; as the clogging degree of the filter mesh increases, the rotation speed of the motor 21 decreases, and the electrical current value of the motor 21 decreases correspondingly.

The third condition is a manual switching instruction condition. Setting the manual switching instruction condition can improve the flexibility of switching mode and enhance the user experience.

The above three switching conditions respectively correspond to three switching control policies, namely, a periodic switching mode to achieve self-cleaning, an automatic detecting and switching mode to achieve self-cleaning, and a manual switching mode to achieve self-cleaning.

In some embodiments, the backwashing mode further includes: after controlling, by the water pump 2, the water flow to flow through the filtering device 3 in a reverse direction, controlling, by the water pump 2, the water flow to flow through the filtering device 3 in a forward direction. Based on the above step, in the backwashing mode, the water pump 2 can generate reverse water flow and forward water flow sequentially, thereby generating the oscillation of the water flow, being conducive to the impurities to fall off the filter mesh, and improving the cleaning effect.

Furthermore, in some embodiments, the backwashing mode further includes: controlling the water pump 2 to stop operating in an interval between generating the forward water flow and generating the reverse water flow. Based on the above step, the motor 21 in the water pump 2 rotates in the forward direction to generate the forward water flow, then the motor 21 stops for a fixed period of time, then the motor 21 rotates in the reverse direction to generate the reverse water flow, then the motor 21 stops for a fixed period of time again, and then repeats the above actions, so that the water pump 2 may be periodically switched to generate pulse water flow, thereby enhancing the oscillation of the water flow and improving the cleaning effect.

Furthermore, in some embodiments, the duration of controlling the water flow to flow through the filtering device in the reverse direction is in a range of 2 s-15 s. Based on the above steps, in the backwashing mode, the duration of a single reverse water flow is defined, in cooperation with the alternating of the forward rotation and reverse rotation in the above embodiments, which can further improve the cleaning efficiency.

In some embodiments, the backwashing mode further includes: controlling the motor 21 in the water pump 2 to rotate at different speeds. Based on the configuration, the motor 21 rotates at different speeds, correspondingly the flow speed of the water flow varies, and the collision of the high-speed water flow and the low-speed water flow in the flow channel can also form the oscillation of the water flow.

Embodiments of the present disclosure further provide an electronic device that includes a processor and a memory, at least one instruction or at least one program being stored in the memory and loaded and executed by the processor to implement the method of controlling the hand-held swimming pool cleaning apparatus as described above.

The memory may be used to store software programs and modules, and the processor may execute various functional applications and data processing by executing the software programs and modules stored in the memory. The memory may mainly include a program storage area and a data storage area, where the program storage area may store an operating system, an application program for performing a function, etc.; the data storage area may store data created according to the use of the device, etc. In addition, the memory may include a high-speed random access memory and may also include a non-volatile memory, such as at least one hard disk memory device, a flash memory device, or other volatile solid state memory device. Accordingly, the memory may also include a memory controller to provide the access of the processor to the memory.

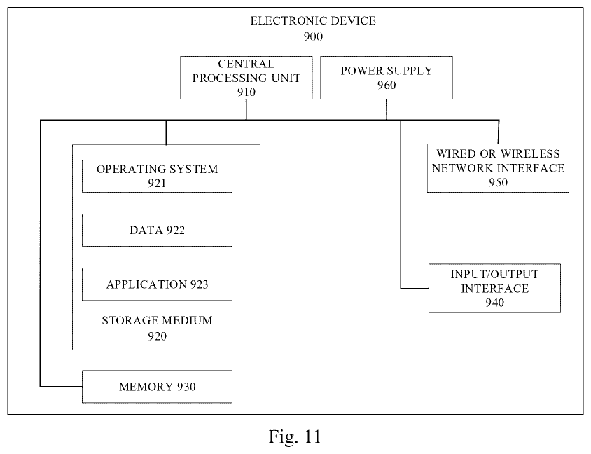

The method embodiments provided by the embodiments of the present disclosure may be executed in an electronic device such as a mobile terminal, a computer terminal, a server or a similar computing device. FIG. 11 is an electronic device provided by an embodiment of the present disclosure. As shown in FIG. 11, the electronic device 900 may vary widely depending on configuration or performance and may include one or more Central Processing Units (CPU) 910 (the CPU 910 may include, but not limited to, a microprocessor MCU or a programmable logic device FPGA or other processing devices), a memory 930 for storing data, one or more storage media 920 (such as one or more massive storage devices) for storing an application 923 or a data 922. The memory 930 and the storage medium 920 may each be a transient storage or a persistent storage. The program stored in the storage medium 920 may include one or more modules, each of which may include a series of instructional operations for an electronic device. Still further, the central processing unit 910 may be configured to communicate with the storage medium 920 to execute a series of instructional operations in the storage medium 920 on the electronic device 900. The electronic device 900 may also include one or more power supplies 960, one or more wired or wireless network interfaces 950, one or more input/output interfaces 940, and/or one or more operating systems 921, such as Windows Server™, Mac OS X™, Unix™, Linux™, FreeBSD™, etc.

The input/output interface 940 may be used to receive or transmit data via a network. A specific example of the network may include a wireless network provided by a communication provider of the electronic device 900. In an example, the input/output interface 940 includes a Network Interface Controller (NIC) that may be coupled to other network devices via a base station and thereby may communicate with the Internet. In an example, the input/output interface 940 may be a Radio Frequency (RF) module for communicating wirelessly with the Internet.

As can be appreciated by persons of ordinary skill in the art, the structure shown in FIG. 11 is illustrative only and is not intended to limit the structure of the electronic device. For example, the electronic device 900 may further include more or fewer components than those shown in FIG. 11, or have a configuration different from that shown in FIG. 11.

Embodiments of the present disclosure further provide a storage medium having stored therein at least one instruction or at least one program that is loaded and executed by a processor to implement the method of controlling the hand-held swimming pool cleaning apparatus as described above.

Embodiments of the present disclosure further provide a computer program product including computer instructions which, when executed by a processor, implement the method of controlling the hand-held swimming pool cleaning apparatus as described above.

Various embodiments of the present disclosure have been described above, the above description is illustrative, not exhaustive, and not limited to the various embodiments disclosed. Many modifications and variations will be apparent to persons of ordinary skill in the art without departing from the scope and spirit of the various embodiments illustrated. The selections of terms used herein are intended to best explain the principles, practical applications, or technical improvements in the market of the various embodiments, or to enable persons of ordinary skill in the art to understand the various embodiments disclosed herein

I/We claim:

1. A hand-held swimming pool cleaning apparatus, comprising:
a housing comprising at least one water suction inlet and at least one water discharge outlet;
a water pump and a filtering device, wherein operating mode of the water pump comprises a filtering mode and a backwashing mode, and in the filtering mode, the water pump enables water flow to flow in through the water suction inlet, pass through the filtering device and flow towards and out of the water discharge outlet;
wherein the filtering device is detachably connected to the housing; and
wherein the water pump is switchable from the filtering mode to the backwashing mode; in the backwashing mode, the water pump enables the water flow to pass through the filtering device along a direction opposite to a water flow direction in the filtering mode, to wash the filtering device.

2. The hand-held swimming pool cleaning apparatus according to claim 1, wherein the water pump comprises a motor and an impeller, the water pump enters the filtering mode in a case where the motor rotates in a forward direction, and the water pump enters the backwashing mode in a case where the motor rotates in a reverse direction.

3. The hand-held swimming pool cleaning apparatus according to claim 2, wherein the filtering device further comprises an outer cover and a filtering member, the outer cover is detachably connected to the housing, and at least a part of the filtering member is placed within the outer cover.

4. The hand-held swimming pool cleaning apparatus according to claim 3, wherein the outer cover comprises a handle.

5. The hand-held swimming pool cleaning apparatus according to claim 4, wherein the filtering member comprises a water flow inlet, and a one-way valve is disposed at the water flow inlet.

6. The hand-held swimming pool cleaning apparatus according to claim 3, wherein the outer cover is provided with an opening, and the opening communicates with the water suction inlet.

7. A method of controlling a hand-held swimming pool cleaning apparatus, wherein operating mode of the hand-held swimming pool cleaning apparatus comprises a filtering mode and a backwashing mode, and the method comprises:
in a case where the hand-held swimming pool cleaning apparatus is in the filtering mode, controlling, by a water pump, water flow to flow in through a water suction inlet, pass through a filtering device, and flow towards and out of a water discharge outlet;
in a case where the hand-held swimming pool cleaning apparatus is switched to the backwashing mode, controlling, by the water pump, the water flow to pass through the filtering device along a direction opposite to a water flow direction in the filtering mode to wash the filtering device;
wherein the backwashing mode is switched based on one of following conditions:
duration in which the hand-held swimming pool cleaning apparatus is in the filtering mode having reached a preset duration condition, or clogging of the filtering device having been detected, or a backwash control button on the hand-held swimming pool cleaning apparatus having been triggered.

8. The method according to claim 7, wherein the backwashing mode further comprises: after controlling, by the water pump, the water flow to flow through the filtering device in a reverse direction, controlling, by the water pump, the water flow to flow through the filtering device in a forward direction.

9. The method according to claim 8, wherein the backwashing mode further comprises: controlling the water pump to stop operating in an interval between generating forward water flow and generating reverse water flow.

10. The method according to claim 8, wherein duration of controlling the water flow to flow through the filtering device in the reverse direction is in a range of 2 s-15 s.
